(19) United States
(12) Patent Application Publication
(10) Pub. No.: US 2025/0201082 A1
(43) Pub. Date: Jun. 19, 2025

(54) Dual Option Rapid Betting Platforms and Methods

(71) Applicant: Oleg Avtsen, Tel Aviv Jaffa (IL)

(72) Inventor: Oleg Avtsen, Tel Aviv Jaffa (IL)

(21) Appl. No.: 18/845,833

(22) PCT Filed: Mar. 24, 2022
(86) PCT No.: PCT/US2022/021638

§ 371 Date: Sep. 10, 2024

(51) Int. Cl. G07F 17/32

(52) U.S. Cl. CPC G07F 17/3288; G07F 17/3209; G07F 17/323

(57) ABSTRACT

A dual option network-based betting platform is configured to accept original bets from registered users. The platform is also configured to accept replicated bets as placed by other users. Bet replication may be done using a single action, such as swiping the bet record card in a predefined direction. Using a single action to accept or reject bets of others allows the user of the platform to rapidly place a large number of bets in a short period of time.

### CROSS-REFERENCE DATA

The present patent application is a national stage filing of the PCT application No. PCT/US22/21638 filed on 24 Mar. 2022 by the same inventor and with the same title, which is incorporated herein by reference in its entirety.

### BACKGROUND

Without limiting the scope of the invention, its background is described in connection with remote and online betting. More particularly, the invention describes a dual-option betting platform where users have a first option of creating original bets and a second option of rapidly accepting and replicating bets of other users.

Betting on sports and other events is a multi-billion-dollar business. Casinos, for example, have large sports and event betting parlors for attracting bettors. These parlors display the bets that a person may make on various sports or other types of events. Large displays are typically used to inform the players of a multitude of events and current bets. Information on these displays is constantly changing to reflect changing bets. Bets may be placed on most major sports including professional and college football, soccer, baseball, basketball, auto racing, and ice hockey, as well as cricket and rugby. Further, bets may be placed on various sports tournaments, including the NCAA Men's and Women's Basketball Championships and World Cup Soccer. Also, bets may be placed on other types of events with multiple possible outcomes, including, for example, a selection of the winner of a reality television show (e.g., the Survivor reality show), election results, weather events, the winner of the next United States Presidential election, or any other type of event.

In general, gambling is understood as wagering, or betting, of money or something of material value (also referred to as “the stakes”) on one or more projected outcomes of an event with an uncertain outcome with the primary intent of winning additional money and/or material goods. Typically, the outcome of the wager, or bet, is evident within a short period of time.

A variety of betting arrangements are known in the field, such as fixed odds betting and parimutuel betting, which frequently occur at many types of sporting events, and political elections. In addition, many bookmakers offer fixed odds on a number of non-sports-related events; for example, the direction and extent of movement of various financial indices, or election results. Interactive prediction markets also offer trading on these outcomes; with “shares” of results trading on an open market. One of the most widespread exemplary forms of non-sports gambling involves betting on horse or dog racing.

The Internet and the increasing availability of broadband services have led to the expansion of local betting to include remote users or bettors (these two terms are used herein interchangeably), giving rise to a proliferation of online betting and gambling. In general, to participate in online gambling activities, such as placing bets on the projected outcomes of sporting events, a user must open an account with an online betting platform, which typically includes a deposit or credit account. Once the user's account is open, validated, and funded, the user may participate in online betting activities using the funds or balance available in his or her account.

It is fairly easy to follow just a few events when betting online. However, once the number of possible betting events increases, a typical user may have a tough time understanding all the details of betting on an individual event given a broad variety and a rapid succession of updates accompanying each event. One way to accommodate such a user is to allow that user to replicate bets by others, especially those that the user trusts or follows.

The need exists therefore for a betting platform that is configured to service both types of users, those who prefer to make their own original bets, as well as those who may elect to join other bettors and use for themselves at least some or all of the details and conditions of the bets created by other users.

### SUMMARY

Accordingly, it is an object of the present invention to overcome these and other drawbacks of the prior art by providing a novel betting platform accessible to a variety of users with different user preferences.

It is another object of the present invention to provide a betting platform allowing rapid placement of multiple bets.

It is another object of the present invention to provide a betting platform allowing placement of individual bets with a single motion, gesture, or another single input by the user.

It is a further object of the present invention to provide a betting platform allowing some users to follow the betting action of other users.

It is a further yet objective of the present invention to provide a betting platform allowing a user to place and follow many bets on multiple events over a short period of time.

A dual option rapid betting platform of the present invention may include a server accessible via an electronic communications network such as the Internet by a plurality of registered users via their respective electronic user devices. The platform server may include a controller operating at least one or more electronic computer processors, as well as a memory with at least one database.

As contrasted to the prior art, the present invention is advantageous in that the controller is operatively interacting with the plurality of electronic user devices and configured to execute the following steps:
(a) providing a first betting option to create an original individual bet. This option may be provided to one, several, or all registered users of the platform. The original bet may be defined as a first user selecting at least one projected outcome of a selected event and betting a first wage thereon;
(b) upon validation of at least one original bet, providing a second betting option by operating a plurality of electronic user devices to display the original bet to some or all registered users (as defined by the first user) and allowing these some or all registered users to rapidly create a replicated bet. The replicated bet may be defined by a second user repeating the original bet of the first user for themselves, namely by repeating a bet on the same at least one projected outcome of the selected event and betting a first wage or a second wage thereon;
(c) upon validation of each replicated bet, operating the controller to inform same users as in step (b) about acceptance of their replicated bets and updating the original bet information with information disclosing all replicated bets;
(d) continuing operating the controller of the platform to perform steps (a) through (c) until the actual outcome of the selected event is determined, and
(e) informing all users of steps (a) and (b) of the actual outcome and results of their bets.

The electronic user devices may be configured to allow either one or both of the first betting option and the second betting option to be exercised by one, several, or all registered users of the betting platform. In addition, respective electronic user devices may be configured to provide updated information about original bets and replicated bets to at least some or all of the registered users.

In further embodiments, the betting platform may be further configured to allow a public or a private designation for the original bet, which may trigger automatic notification of all or only some of the platform users about the creation of the original bet. Such public or private designation may be selected by the first user when making the original bet.

In further yet embodiments, the betting platform may be configured to allow an individual user to receive updated information for some or all of the newly created original or rapidly replicated bets by other users. One or more filters may be provided as part of the individual user interface, as operated by the individual electronic user device. Such filters allow the user to reduce the stream of original bets and replicated bets being displayed for the user. In one example, this may be accomplished by selecting the types of events for betting, selecting one or more other users so as to follow their bets, as well as adjusting other configuration settings for a better individual experience.

One further example of other settings is selecting a cumulative maximum wagering amount, which is not to be exceeded. In that case, no additional rapidly replicated and/or original betting may be allowed upon the user reaching the predefined cumulative wagering amount.

### BRIEF DESCRIPTION OF THE DRAWINGS

Subject matter is particularly pointed out and distinctly claimed in the concluding portion of the specification. The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through the use of the accompanying drawings, in which:

FIG. 1 is a schematic view of the betting platform's general architecture,

FIG. 2 is a flow diagram of the creation of original bets, notifications, and creation rapid bet replications by various users of the betting platform,

FIG. 3 is a detailed flow diagram of the creation of original bets, replicated bets, and notifications to and from various users of the betting platform,

FIG. 4 is a block diagram of various components of the betting platform of the invention,

FIG. 5 is an exemplary screen view of a home screen for a user showing a stack-up of the plurality of record cards of various bets by other users,

FIG. 6 is an exemplary screen view of the same but in this case, swiping to the right causes the record card to be replicated as a “bet” from the user,

FIG. 7 is an exemplary screen view of the feed of updated and/or newly created record cards to the user, and

FIG. 8 is an exemplary screen view of all the filters available to the user.

### DETAILED DESCRIPTION OF PREFERRED EMBODIMENTS OF THE INVENTION

The present invention will now be described in detail with reference to a few preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well-known process steps and/or structures have not been described in detail in order to not obscure the present invention.

One or more different inventions may be described in the present application.

Further, for one or more of the invention(s) described herein, numerous embodiments may be described in this patent application, and are presented for illustrative purposes only. The described embodiments are not intended to be limiting in any sense. One or more of the invention(s) may be widely applicable to numerous embodiments, as is readily apparent from the disclosure. These embodiments are described in sufficient detail to enable those skilled in the art to practice one or more of the invention(s), and it is to be understood that other embodiments may be utilized and that structural, logical, software, electrical, and other changes may be made without departing from the scope of the one or more of the invention(s). Accordingly, those skilled in the art will recognize that one or more of the invention(s) may be practiced with various modifications and alterations. Particular features of one or more of the invention(s) may be described with reference to one or more particular embodiments or figures that form a part of the present disclosure, and in which are shown, by way of illustration, specific embodiments of one or more of the invention(s). It should be understood, however, that such features are not limited to usage in one or more particular embodiments or figures with reference to which they are described. The present disclosure is neither a literal description of all embodiments of one or more of the invention(s) nor a listing of features of one or more of the invention(s) that must be present in all embodiments.

Devices that are in communication with each other need not be in continuous communication with each other unless expressly specified otherwise. For example, at least one or several of the electronic user devices may be activated and connected to the betting platform intermittently or from time to time. In addition, electronic user devices that are in communication with each other and/or with the server of the betting platform may communicate directly or indirectly through one or more intermediaries.

A description of an embodiment with several components in communication with each other and with the server does not imply that all such components are required. On the contrary, a variety of optional components are described to illustrate the wide variety of possible embodiments of one or more of the invention(s).

Further, although process steps, method steps, algorithms, or the like may be described in a sequential order, such processes, methods, and algorithms may be configured to work in alternate orders. In other words, any sequence or order of steps that may be described in this patent application does not, in and of itself, indicate a requirement that the steps be performed in that order. The steps of the described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred.

When a single device or article is described, it will be readily apparent that more than one device/article (whether or not they cooperate or are operatively connected) may be used in place of a single device/article. Similarly, where more than one device or article is described (whether or not they cooperate), it will be readily apparent that a single device/article may be used in place of more than one device or article.

The functionality and/or the features of a device may be alternatively embodied by one or more other devices that are not explicitly described as having such functionality/features. Thus, other embodiments of one or more of the invention(s) need not include the device itself.

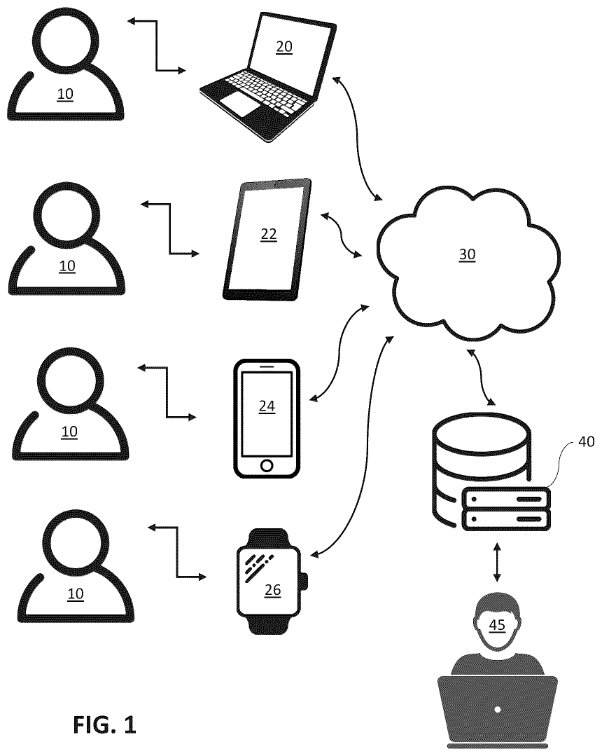

FIG. 1 shows a general view of the novel betting platform of the present invention. The betting platform is based on a controller 40 accessible via an electronic communication network 30 or by direct connections by a plurality of users 10 via their respective electronic user devices 20, 22, 24, and 26. Users 10 may be individual persons, bookmakers, other betting dealers, or other individuals or groups, who are interested in participating in the betting process facilitated by the betting platform of the present invention. The platform administrator 45 may also act as a registered user. In further embodiments, Artificial Intelligence bots may also function as a registered user on the betting platform as the invention is not limited in this regard.

Each user may go through a one-time user registration process setting up a user account, log-in information, and user preferences, such as filters as described below in greater detail. The user may then be allowed to fund the account with the initial amount of money using preferred or multiple currencies as set by the platform administrator 40.

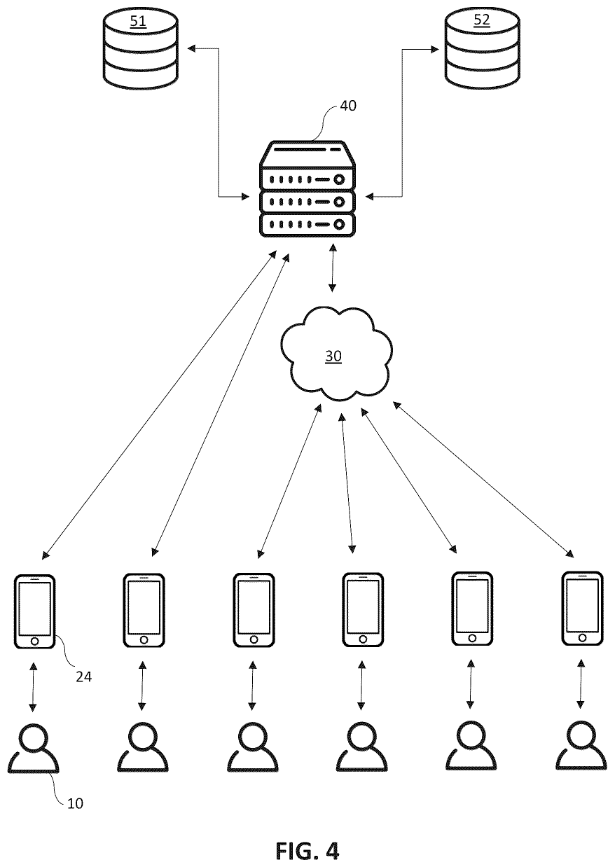

The electronic communication network 30 may be organized using wired communications, wireless communications, or a combination thereof as the present invention is not limited in this regard. FIG. 1 shows the electronic communications network 30 as the Internet but other arrangements are also contemplated to be covered by the scope of the claims of the present invention. One example of additional arrangements is seen in FIG. 4, depicting one or more users with their respective electronic user devices connected directly to server 40 (on the left side of FIG. 4) with other users having their respective electronic user devices connected to the server 40 via the Internet network 30. Further examples are also contemplated and while not shown in the drawings, they may include intermediate ISP (internet service providers), home-based networks, cellular networks, etc. as the invention is not limited in this regard. Preferably, all wireless communication is conducted using a variety of known secure transmission protocols, so as not to jeopardize the interests and security of the personal data of registered users.

A variety of types of electronic user devices may be used in conjunction with the present invention. Examples of such devices include personal computers and laptops 20, tablets 22, smartphones 24, smartwatches 26, etc. as the invention is not limited in this regard. Advantageously, but not necessarily, such devices may include a touch-sensitive display, which allows for rapid betting by a single touch action, such as swiping as explained below in greater detail. Each electronic user device may be configured to facilitate a log-in process by a registered user 10. Upon logging in, the electronic user device may be configured to display user-configurable information suitable for the individual user 10.

In embodiments, it may be advantageous to maintain a continuous wired or wireless connection between the electronic user device and the server 40—so that all relevant betting updates are rapidly transmitted as notifications to the user and all betting actions by the user are rapidly transmitted to the server 40 for registration, vetting and further disposition. In other embodiments, an intermittent connection between the electronic user device 20 and the server 40 may still be permitted, given that the bet is received on time and prior to the expected outcome of the event being known and communicated to other users.

Server 40 may comprise one or more individual controllers operating one or more electronic computer processors. The server 40 may further include one or more memory units housing one or more databases. In one example shown in FIG. 4, a first database 51 may be operatively connected or integrated with server 40 and configured to store a roster of registered users. A second database 52 may be configured to store a roster of events. Additional stand-alone or integrated databases may be used to store other pertinent information necessary for the operation of the betting platform of the present invention. The server 40 may be operated and monitored by the platform administrator 45.

In embodiments, initial user notification about events as well as updates on the most current bets placed on these events may be generated by the server 40 using a suitable database 52. In other embodiments, such information may be transmitted by other bookmakers and betting dealers, in which case the server 40 may be configured to aggregate betting information from one or several other sources. The server 40 may further be configured to present betting information to users 10 in a single unified manner as described, for example, in my other co-pending patent applications in greater detail.

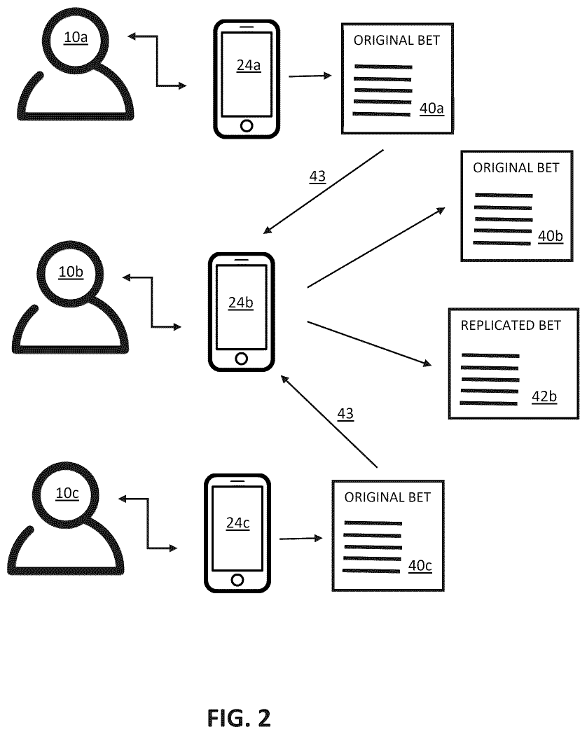

The betting platform described herein is advantageous as compared to other known betting platform for a number of reasons, mainly because it allows for various types of betting, including creating of original de-novo bets, as well as rapid replication of original bets by other users. One example of this process is schematically illustrated in FIG. 2.

Three users are shown in FIG. 2. For the purposes of this illustration, users 10a and 10c are shown as exercising a first betting option and creating original bets 40a and 40c respectively using their electronic user devices 24a and 24c. The user 10a, for example, may select a particular event for betting thereon. These events are presented to the user 10a by server 40 and may be typically characterized by having more than one possible outcome, which is not determined yet at the time of placing the bet. The user may set a filter to only be notified about a certain type of event. In other embodiments, the user is notified about all upcoming events. The user 10a may be invited to select the event and then select one or more projected outcomes for the event. The user may also be invited to bet on a certain order of outcomes, for example on the first-place winner and the second-place winner in a horse race. Other possible bets may also be provided as options to the user 10a to place a bet on as the invention is not limited in this regard.

Following the selection of a projected outcome, the user 10a may be invited to define the amount of the first wage that the user is betting on the selected projected outcome. The user 10a may be invited to provide further betting details or conditions as may be determined by the platform administrator 45.

For user 10a, his or her original bet 40a may be then securely transmitted by the electronic user device 24a to the server 40 via the communications network 30 (not shown). The original bet 40a may be then validated by the server 40, the first wage may be checked against the available balance of funds for the user 10a, and bet 40a may then be accepted. In other embodiments, the server 40 may be configured to transmit the original bet 40a to a third-party bookmaker or a betting dealer if one is registered on the betting platform of the invention. The third-party bookmaker may then accept the original bet after verification, adjustment, or another third-party operation as required by that third party. In either case, once the original bet 40a is validated, a notification 41 may be generated by server 40 and transmitted via the electronic communications network 30 to other registered users on the platform.

In embodiments, the user 10a may have the option to designate the original bet 40a as either public or private. One of these designations may be provided to the original bet as a default. In case the original bet is designated as public, notification 41 will be transmitted to all registered users on the platform. In case the original bet is designated as private, user 10a may have an option of selecting one or several favorite registered platform users that will receive this notification 41 upon validating the original bet 41. From that point on, all other bets of the selected group of favorite registered users may trigger additional notifications, wherein all these additional notifications and updates will be transmitted only to the selected group of favorite registered users and not to everyone else on the platform. The user 10a who originally selected the private group of other registered users may have an option of editing the list to include or exclude additional users. Other users of the private group may be able to invite further registered users, but these invitations may need the approval of the original bet creator, user 10a in this example.

Continuing with the example in FIG. 2, both users 10a and 10c have now created original bets 40a and 40c respectively. For the purposes of continuing illustration of this example, the original bet 40a is a private bet with user 10b included in the group for notification purposes, while the original bet 40c is a public bet.

User 10b may be notified by server 40 via messages 41 about the creation and acceptance of the original bets 40a and 40c by other users on the platform. In response, after reviewing the information of the record cards for original bets 40a and 40c (which is described in greater detail below), the user 10b may elect to exercise a second betting option, namely to replicate the bet 40a or 40c for themselves as a replicated bet 42b. Such replication of the bet may be done very rapidly, in some examples with a single action of the user 10b, such as swiping the record card in a certain direction, as explained in greater detail below.

The user 10b may elect to reject the bet 40a or 40c—in which case this rejection may also be done very rapidly, for example, by swiping the record card in another direction on the screen of the electronic user device 24b.

The user 10b may still have an option of creating his/her own individual original bets 40b as well as accepting or rejecting original bets by other users as the invention is not limited in this regard. Every time a user creates a replicated bet or an original bet, server 40 may be configured to notify some or all other users (depending on whether the new bet is public or private) about the creation of the new bet and a corresponding change of the overall betting odds, if that is the case. One example of such additional information provided to all respective registered users is a display of decimal odds associated with the particular projected outcome of a selected event. Decimal odds may typically represent the total return for every unit of currency wagered, including the money the user risked.

The betting platform may be further configured to notify each user who placed either the original or a replicated bet as to whether their bet is accepted by the server 40. In some cases, a bet may be rejected by the server 40, for example, if the balance of the user's account is not sufficient to cover the requested bet. In other embodiments, the server 40 may be configured to invite the user to correct any identified deficiencies in the requested bet, for example, lower the wagering amount to be within the limits of the account balance of the user. In further yet embodiments, the server 40 may be configured to offer a remedy to a bet deficiency, such as, for example, open a credit line for a bettor with insufficient funds, if the user is deemed creditworthy by the platform administrator 45.

The betting platform may be operated to continuously accept various original and/or replicated bets from multiple users of the platform and notify other users associated with the same event until a certain cut-off point, for example, a predefined time or a predefined state of the event. Typically, respective users are informed as to the cut-off point in advance, so they have an ample chance to make their bets. One example of a cut-off state of the event may be a start of a horse race, or, in other examples, a finish of a horse race. Typically, all bets are collected well before there is a determination of the specific outcome of the event.

Once the event outcome has been determined, the server 40 may be configured to determine the outcome of each placed bet on that event and to determine a monetary remuneration to be transmitted to the accounts of the winners. All users who placed a bet in a certain event may be notified about the actual outcome thereof and the disposition of their bets.

The betting platform of the present invention may be therefore configured to conduct the following steps during its operation:
(a) providing a first betting option for some or all registered users 10a, 10b, and 10c to create an original individual bet 40a, 40b, or 40c, the original bet is characterized by a first user 10a selecting at least one projected outcome of a selected event and betting a first wage on said selected at least one projected outcome,
(b) upon validation of at least one original bet 40a by the first user 10a, providing a second betting option by displaying the original bet 40a to some or all registered users and allowing to rapidly create a replicated bet 42b, the replicated bet is characterized by a second user 10b repeating the original bet 40a of the first user 10a by repeating a bet on the same projected outcome of the selected event and betting a first wage or a second wage thereon,
(c) upon validation of each replicated bet 42b, informing same users as in step (b) about acceptance thereof and updating the original bet 40b with information disclosing replicated bets 42b,
(d) continuing operating the controller 40 to perform steps (a) through (c) until the actual outcome of the selected event is determined, and
(e) informing all users 10a, 10b, and 10c of steps (a) and (b) of the actual outcome and results of their bets.

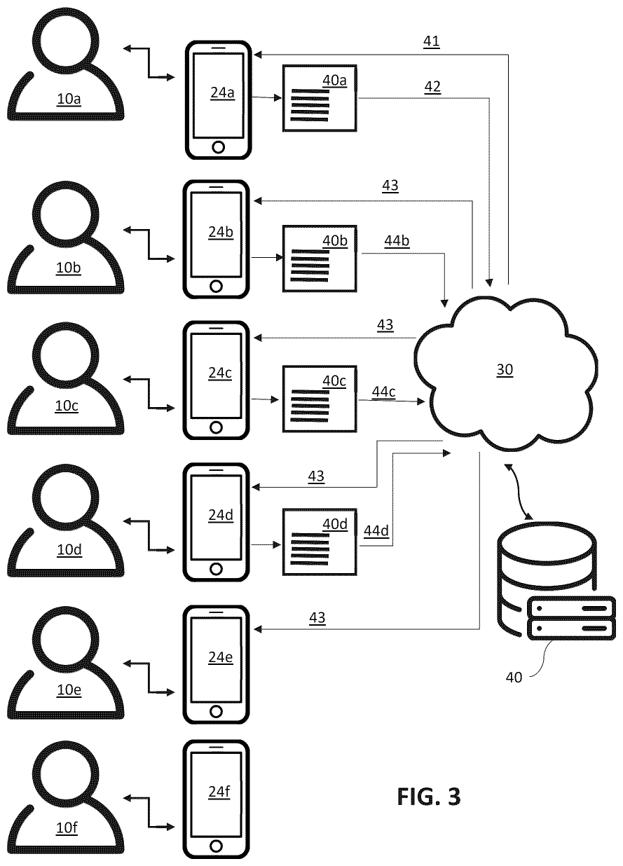

Another example of the betting platform configuration and operations is shown in FIG. 3, where a plurality of users 10a, 10b, 10c, 10d, 10e, and 10f have their respective electronic user devices 24a through 24f operatively connected to the controller 40 of the betting platform of the invention. Controller 40 may be configured to transmit information about the availability of an event to place bets on via communications 41 to all users (only one arrow is seen in FIG. 3 for clarity of depiction). Some of the users may select to not receive information for particular types of events as dictated by their individual preferences and filter settings as described in greater detail below.

Upon receipt of the information about the future events and their projected outcomes, one or more users 10 may decide to place an original bet on the event. In the example shown in FIG. 3, user 10a places an original bet 40a via the electronic user device 24a associated with that user. Information about the original bet 40a is then transmitted to controller 40 via the network 30 by a message 42. Upon validation at the controller 40, a notification 43 may be sent to some or all of the users 10 about the creation of the original bet including the details of the projected outcome as well as the first wage placed by the user 10a on the selected event. If user 10a selects the bet to be public, notification 43 may be sent to all registered users on the betting platform. This notification may be transmitted as a separate note to the users 10 or, in the alternative, the bet card for the selected event may be updated with information about the original bet 40a. In the example shown in FIG. 3, the user 10a elects to list the bet 40a as private and designates only users 10b, 10c, 10d, and 10e as followers of the original bet. In this case, the controller 40 may be configured to notify and/or update bet card for the selected event for these designated users only. User 10f in this case may not be notified about the creating of the original bet 40a.

In response to the notification from the controller 40 about the creation of the original bet 40a by user 10a, some or all of the privately-notified users may elect to replicate the bet 40 for themselves, either as an exact copy or by adjusting at least one parameter of the original bet 40a. In one example, user 10b elects to replicate bet 40a exactly the same way by transmitting the replicated bet 40b via the electronic user device 24b to controller 40 using a message 44b.

User 10c may elect to modify the original bet 40a and transmit a modified bet 40c via a message 44c, for example by adjusting the first wave to be a second wage. Similarly, user 10d may elect to send a message 44d containing a modified bet 40d to the controller 40. User 10e may elect to not accept the original bet 40a at all and not respond by placing a bet on the selected event.

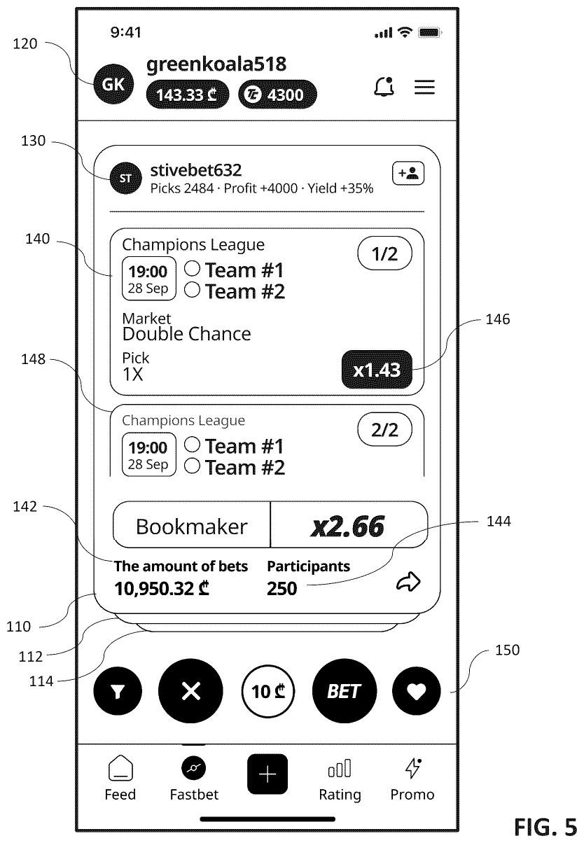

FIGS. 5-7 depict exemplary screenshots of various aspects of the operation of the single electronic user device, which are now described in greater detail. The form factor of each screen shown in FIG. 5-7 is illustrative of a form factor optimized for a smartphone display. Other form factors are certainly known as best fitting other electronic devices and are intended to be used for the purposes of the present invention.

FIG. 5 is an exemplary screen view of a home screen for a user showing a stack-up of the plurality of bet record cards 110, 112, and 114 of various bets by other users. The home screen may also contain the screen name of the user and/or its short abbreviation 120. Each bet record card of the initial stack-up of cards may be first presented in a compressed form showing only a summary of the event and other bet data, such as a panel 140, for example, the screen name of another bettor 130, the time and the nature of the event 140 that the other bettor 130 is betting on, current decimal odds 146, the total amount of all bets on this events 142, the number of bettors for this event 144 and other information as determined by the platform administrator.

A single user may place more than one original bet on the same or different events. The home screen may present all of the various original bets of the same single user (stivebet632 in the example seen in FIG. 5) as a number of several panels. In this example, the user can see two panels: a panel 140 (panel one of two) and panel 148 (panel two of two).

Various currency units may be used for the betting purposes of the platform of the present invention. The server 40 may be configured to accept a local currency, such as a total pool of 10,950.32 Georgian Lari shown in FIG. 5. The server 40 may be further configured to accept other currency units, such as US dollar, Euro, etc., and convert other currency into a preferred local currency at a predetermined rate, which may be set daily or adjusted from time to time depending on market conditions.

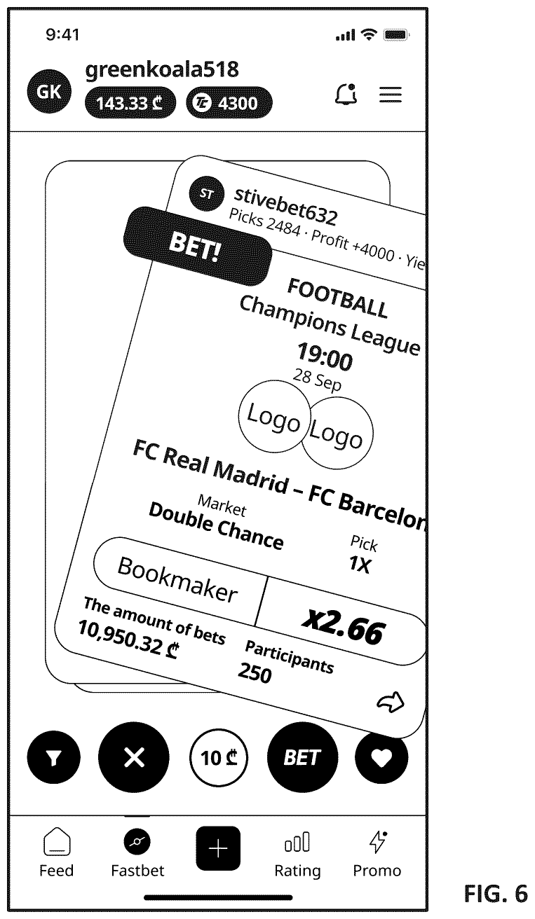

One of the advantages of the betting platform of the present invention is the ability to instantly place or reject a proposed bet with a single action. In one non-limiting example, swiping the bet record card in one predetermined direction may automatically cause the action of placing a replicating bet by the user, as illustrated in FIG. 6. In the same example, swiping the record card in another direction may be configured to cause the user interface to reject the bet for the user.

A single-action rapid betting is not limited to the swiping action of the record card off the screen. Other examples of a single gesture, voice command, or another single action may also be used for rapidly accepting or rejecting bets of others. One example is a voice recognition feature that may be configured to recognize ACCEPT or REJECT voice commands for a respective further action. Other similar voice commands may also be included in the list of recognized commands, for example, YES and NO, etc. Similar commands in other languages may also be included as part of the operation for a typical user interface of the present invention.

Once the top bet record card is decided upon by the user, the user interface may be configured to automatically remove the top bet record card from the home screen and present the next record card to the user. Using a single action for accepting or rejecting a top proposed bet on a home screen can advantageously allow the user to place a large number of replicating bets in a very short period of time.

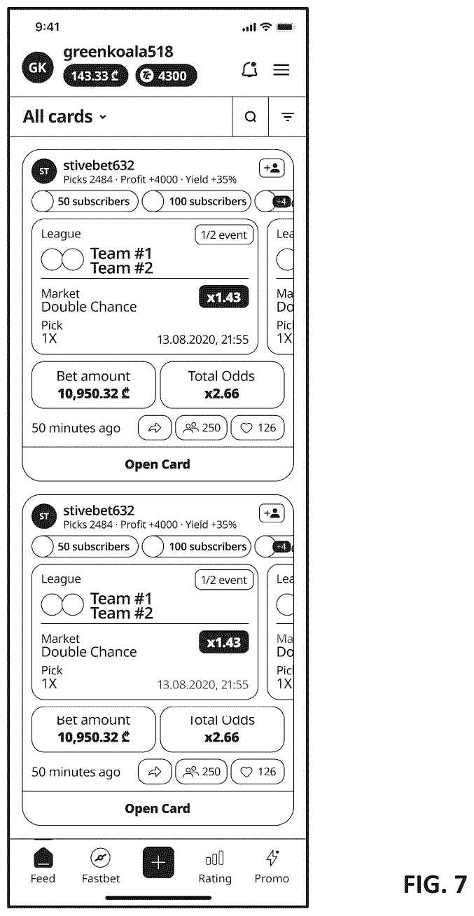

FIG. 7 shows an example of displaying a stream of various updated bet record cards to the user. In contrast to the stack-up of record cards described earlier, FIG. 7 shows an example of a continuous feed of updated bet record cards for various events, as may be limited by the user using the filters described above. Each record card may include a timestamp of the last change. The user may rapidly replicate or reject the bet using a single action as described above in greater detail or elect to see more information by selecting a particular bet record card of interest and clicking an OPEN CARD button.

The betting platform may be further configured to allow an individual user to receive only selected updated information for some but not all original or rapidly replicated bets by other users. This may be done by using one or more user-adjustable filters which may be provided as part of the individual user interface and operated by the individual electronic user device. Such filters allow the user to select the types of events for betting, select one or more other users so as to follow their bets, as well as adjust other configuration settings for a better individual experience.

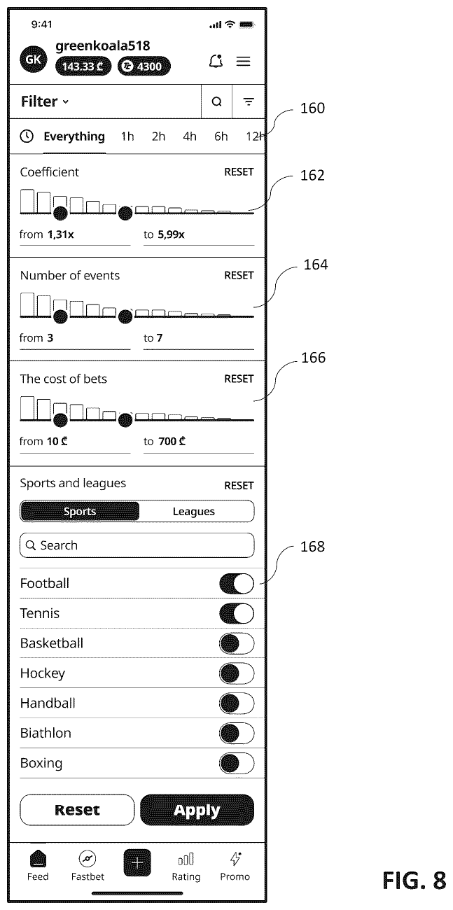

Using filters provides users with a great deal of flexibility and adjustability when using the betting platform of the invention. It is advantageous to reduce the stream of unnecessary information received by the user. FIG. 8 shows an example of various filters that may be user-adjustable to select different events and different bets as preferred by the user. In one example, the user may select to be notified only about events 160 with the outcome to be resolved in a specified period of time, such as within 1, 2, 3, 4, 5, 6, 8, 10, 12, 16, 18, 20, 22, 24 hours, or, in other examples, within 1, 2, 3, 4, 5, 6, 7, 8, 9, 10, 12, 14, 16, 18, 20, 22, 24, 26, 28, 30, 31 days, as the invention is not limited in this regard.

In a further example, the user may select only bets and events filtered by an adjustable value of min and max coefficient 162.

In a further example, the user may select to only see a limited number of events 164.

In a further yet example, the user may select to only see bets within a specified range 166.

In a further yet example, the user may select to see only events and corresponding notifications for certain sports 168, and/or certain leagues within each selected sport. Other similar user-adjusted filters may also be provided by the platform administrator 45 to the user and changed from time to time to make them best suited for the current circumstances.

The betting platform may be configured to allow the user to see a history of all placed bets by that user as well as a history of all transactions involving the user's account. In other embodiments, a user may be given an option to see several or all of his/her current bets and their respective status. In further embodiments, record cards associated with each accepted bet may be sorted by the time of expected receipt of the event outcome so that the record cards with the events closer to their respective outcome are shown on top of record cards with bets that will be adjudicated at a later time.

It is contemplated that any embodiment discussed in this specification can be implemented with respect to any method of the invention, and vice versa. It will be also understood that particular embodiments described herein are shown by way of illustration and not as limitations of the invention. The principal features of this invention can be employed in various embodiments without departing from the scope of the invention. Those skilled in the art will recognize or be able to ascertain using no more than routine experimentation, numerous equivalents to the specific procedures described herein. Such equivalents are considered to be within the scope of this invention and are covered by the claims.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference. Incorporation by reference is limited such that no subject matter is incorporated that is contrary to the explicit disclosure herein, no claims included in the documents are incorporated by reference herein, and any definitions provided in the documents are not incorporated by reference herein unless expressly included herein.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps. In embodiments of any of the compositions and methods provided herein, “comprising” may be replaced with “consisting essentially of” or “consisting of”. As used herein, the phrase “consisting essentially of” requires the specified integer(s) or steps as well as those that do not materially affect the character or function of the claimed invention. As used herein, the term “consisting” is used to indicate the presence of the recited integer (e.g., a feature, an element, a characteristic, a property, a method/process step or a limitation) or group of integers (e.g., feature(s), element(s), characteristic(s), propertie(s), method/process steps or limitation(s)) only.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

As used herein, words of approximation such as, without limitation, “about”, “substantial” or “substantially” refers to a condition that when so modified is understood to not necessarily be absolute or perfect but would be considered close enough to those of ordinary skill in the art to warrant designating the condition as being present. The extent to which the description may vary will depend on how great a change can be instituted and still have one of ordinary skilled in the art recognize the modified feature as still having the required characteristics and capabilities of the unmodified feature. In general, but subject to the preceding discussion, a numerical value herein that is modified by a word of approximation such as “about” may vary from the stated value by at least ±1, 2, 3, 4, 5, 6, 7, 10, 12, 15, 20 or 25%.

All of the devices and/or methods disclosed and claimed herein can be made and executed without undue experimentation in light of the present disclosure. While the devices and methods of this invention have been described in terms of preferred embodiments, it will be apparent to those of skill in the art that variations may be applied to the devices and/or methods and in the steps or in the sequence of steps of the method described herein without departing from the concept, spirit and scope of the invention. All such similar substitutes and modifications apparent to those skilled in the art are deemed to be within the spirit, scope, and concept of the invention as defined by the appended claims.

What is claimed is:

1. A dual option rapid betting platform comprising a server accessible by an electronic communications network by a plurality of registered users via electronic user devices, the server comprising a controller operating at least one processor and a memory with at least one database,
wherein the controller is configured to operatively interact with the plurality of electronic user devices to execute the following steps using the at least one processor in conjunction with the at least one database:
(a) providing a first betting option for some or all registered users to create an original individual bet, the original bet is characterized by a first user selecting at least one projected outcome of a selected event and betting a first wage on said selected at least one projected outcome,
(b) upon validation of at least one original bet, providing a second betting option by displaying the original bet to some or all registered users and allowing to rapidly create a replicated bet, the replicated bet is characterized by a second user repeating the original bet of the first user by repeating a bet on the same at least one projected outcome of the selected event and betting a first wage or a second wage thereon,
(c) upon validation of each replicated bet, informing the same users as in step (b) about acceptance thereof and updating the original bet information with information disclosing replicated bets,
(d) continuing operating the controller to perform steps (a) through (c) until the actual outcome of the selected event is determined, and
(e) informing all users of steps (a) and (b) of the actual outcome and results of their bets.

2. The rapid betting platform as in claim 1 further configured to allow the first user in step (a) to designate the original bet as either public or private, wherein upon selecting a public designation, a notification about the creation of the original bet is communicated to all registered users on the betting platform, and upon selecting a private designation, a notification about the creation of original bet is communicated to a subset of registered users on the betting platform selected by the first user.

3. The rapid betting platform as in claim 1, wherein registered users include at least one or more of an individual user, a betting dealer, a betting platform administrator, or an artificial intelligence bot.

4. The rapid betting platform as in claim 1, wherein upon creation of the original bet in step (a), the platform is further configured to create a bet record card, the betting platform is further configured to update the bet record card upon creation and validation of additional original or replicated bets for the same event by other registered users having access to betting on said event.

5. The rapid betting platform as in claim 4, wherein the updated bet record card is communicated to all users associated with the selected event.

6. The rapid betting platform as in claim 1, wherein each electronic user device is equipped with a personalized user interface configured to show one or more current bets of the user and updates reflecting bets of other users.

7. The rapid betting platform as in claim 6, wherein each electronic user device is further configured to allow the user to select a subset of original and/or replicated bets to be displayed based on one or more filters.

8. The rapid betting platform as in claim 1, wherein the betting platform is further configured in step (b) to accept or reject a replicated bet using a single action of the user.

9. The rapid betting platform as in claim 1, wherein the betting platform is further configured to keep a record of all user bets and display thereof to the user on demand along with a current status of each bet.

10. The rapid betting platform as in claim 1, wherein each electronic user device is configured to allow the user associated therewith to selectively display the first betting option, the second betting option, or a combination thereof.
